(19) United States
(12) Patent Application Publication
(10) Pub. No.: US 2009/0278019 A1
(43) Pub. Date: Nov. 12, 2009

(54) MACHINE HAVING A MACHINE ELEMENT THAT CAN BE MOVED ALONG A CROSSBEAM

(75) Inventors: Jens Hamann, Furth (DE); Uwe Ladra, Erlangen (DE); Elmar Schäfers, Furth (DE); Dietmar Stoiber, Furth (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, MUNCHEN (DE)

(21) Appl. No.: 11/993,689

(22) PCT Filed: Jun. 16, 2006
(86) PCT No.: PCT/EP06/63272

§ 371 Date: Dec. 21, 2007

(30) Foreign Application Priority Data
Jun. 22, 2005 (DE) 10 2005 028 872.3

(51) Int. Cl. B23Q 1/01; B23Q 17/22; F16M 13/00

(52) U.S. Cl. 248/542

(57) ABSTRACT

The invention relates to a machine provided with a machine element (5) movable along a cross-beam (1) and a measuring element (4) for measuring the machine element (5) position, wherein said cross-beam (1) is carried by first and second support elements (2, 3), the cross-beam is fixedly connected to the first support element (2) and movably connected to the second support element (3), the measuring element (4) is fixedly connected to the second support element (3) and movably connected to the first support element (2) The inventive machine makes it possible to reduce the influence of the support elements (2, 3) deformation on the accuracy of measurement of the machine element (5) position.

The invention relates to a machine having a machine element that can be moved along a crossbeam, and a measuring element for measuring a position of the machine element.

High acceleration forces occur in machines, in particular in machine tools, production machines and/or robots, during movement of a movable machine element.

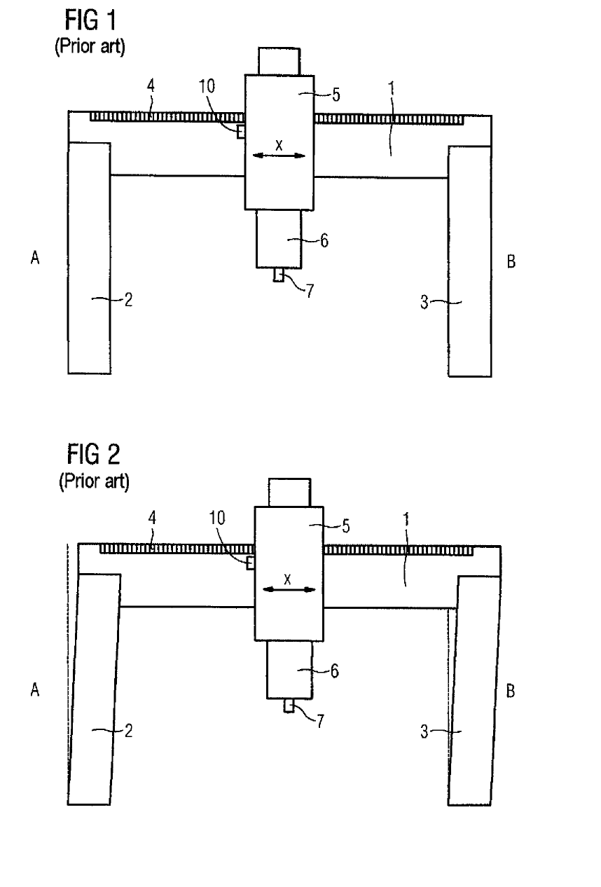

FIG. 1 illustrates a commercially available machine tool having a machine element 5 that can be moved along a crossbeam 1 and is present in the form of a linear motor 5 in FIG. 1, for example. The crossbeam 1 is held on the side of its drive end by a first support element 2, and is held on the side of its non-drive end by a second support element 3. In this case, with such a commercially available machine tool the first support element 2 and the second support element 3 are connected as rigidly as possible in a fixed fashion to the crossbeam 1, for example by means of a welded connection. The crossbeam 1 is therefore unable to carry out movement relative to the first support element 2 or to the second support element 3. A rotary drive 6 that drives a tool 7, for example a milling head, can be moved in the X-direction along the crossbeam with the aid of the linear motor 5, which is carried by the crossbeam 1.

In order to determine the position of the linear motor 5, there is fitted on the linear motor 5 a measuring head 10 that reads a material measure of a measuring element 4 that is fixedly connected to the crossbeam 1. It is possible in such a way to determine a position, that is to say the position of the linear drive 5, and thus the position of the tool 7 along the crossbeam. During dynamic travel movements along the X-axis, the linear motor 5 carried on the crossbeam produces acceleration forces which build-up and decay again in a short time. The counter forces resulting therefrom are transmitted via the crossbeam 1 to the two support elements 2 and 3 that are thereby deformed.

The deformation of the two support elements 2 and 3 occurring in the case of a commercially available machine is illustrated in FIG. 2. The reference symbols of FIG. 2 correspond to the reference symbols of the elements of FIG. 1. The deformation of the support elements leads to a movement (lateral offset) of the crossbeam 1, which also is executed by the measuring element 4 of the position measuring system, because the measuring element 4 is connected to the crossbeam fixedly, that is to say immovably. As a result, during the processing operation of a workpiece large inaccuracies occur that, for example, would not have been expected as such beforehand in a frequency analysis of the movement operation. The less stiff the design of the support elements, the more marked this is as a consequence of the larger amplitudes thereby caused for the deformation of the support elements during processing. The problem stated leads in practice to limitation of the machine dynamics in the case, for example, of commercially available machine tools, production machines and/or robots.

A proposed solution for avoiding this problem is known, for a fixed gantry, from the publication entitled “Werkstatt und Betrieb, Maschinebau, Konstruktion und Fertigung”, in the article “Ruckfrei” [“Jerk-free”] by Dietmar Stoiber and Markus Knorr, Carl Hanser Verlag, Munich, Volume 133 (2000) 6, a separate support frame being used for the measuring element of the measuring system. The separate support frame does not experience any forces during movement of the machine element and therefore remains on the foundation without displacement. The disadvantage of this arrangement consists in the additional support frame for the measuring element and would, in the case of a movable crossbeam, entail an additional machine axis.

It is the object of the invention to create a machine in which the influence of deformation of the support elements on the measuring accuracy of the position of the machine element is reduced.

This object is achieved by a machine having a machine element that can be moved along a crossbeam, and a measuring element for measuring a position of the machine element, the crossbeam being carried by a first support element and a second support element, the crossbeam being fixedly connected to the first support element and being movably connected to the second support element in such a way that the crossbeam and the second support element can be moved relative to one another, the measuring element being fixedly connected to the second support element and being movably connected to the first support element in such a way that the measuring element and the first support element can be moved relative to one another.

It proves to be advantageous that the machine element is designed as a drive. Designing the machine element as a drive constitutes a customary embodiment.

It proves to be advantageous in this context that the drive is designed as a linear drive. Designing the drive as a linear drive constitutes a customary embodiment for machines that have a crossbeam.

Furthermore, it proves to be advantageous that the measuring element is movably connected to the first support element via a first bearing. A movable connection can be implemented in a simple way with the aid of a bearing.

Furthermore, it proves to be advantageous that the crossbeam is movably connected to the second support element via a second bearing. A movable connection can be implemented in a simple way with the aid of a bearing.

Furthermore, it proves to be advantageous that the first bearing and/or the second bearing are/is designed as a plain bearing, magnetic bearing, rolling contact bearing or as a deformable bearing. Designing the first and/or the second bearing as plain bearing, magnetic bearing or rolling contact bearing constitutes customary types of bearings. It is particularly advantageous to design the bearing as a formable bearing. Designing the bearing as a deformable bearing ensures that the participating elements can be moved relative to one another in the X-direction, on the one hand, and that a high transverse stiffness (stiffness in the Y-direction) is provided, on the other hand. If the machine has a further machine axis that permits a movement of machine elements in the Y-direction, that is to say in the direction of the horizontal plane perpendicular to the X-axis, the required stiffness of the arrangement in the Y-direction is ensured with the aid of a deformable bearing.

It proves to be advantageous in this context that the deformable bearing is designed in the form of a plate. By designing the deformable bearing as a plate, in particular in the form of a soft plate, it is possible in a particularly simple way to implement a deformable bearing that permits the elements to be capable of moving relative to one another in the X-direction, but at the same time prevents a movement of the participating elements in the Y-direction owing to its high stiffness.

Designing the machine as a machine tool, production machine and/or as a robot constitutes a customary embodiment of the invention. However, the invention can, of course, also be used for other types of machines.

Two exemplary embodiments of the invention are illustrated in the drawing and explained in more detail below. In the drawing:

FIG. 1 shows a machine tool in accordance with the prior art,

FIG. 2 shows a machine tool in accordance with the prior art and in the case of which a deformation of the support elements occurs,

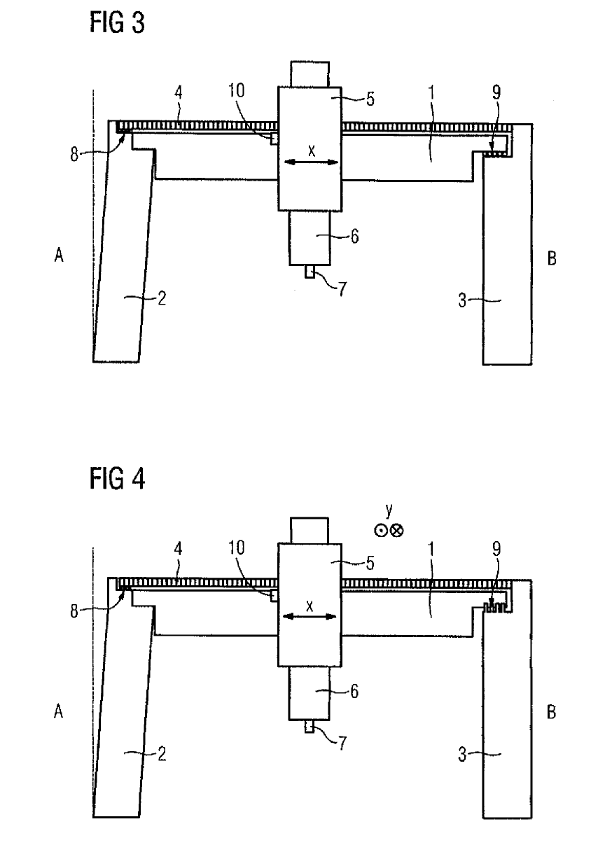

FIG. 3 shows a first exemplary embodiment of an inventive machine, and

FIG. 4 shows a second exemplary embodiment of an inventive machine.

A first exemplary embodiment of the inventive machine in the form of a machine tool is illustrated in FIG. 3. The basic design of the inventive embodiment illustrated in FIG. 3 corresponds substantially to the embodiment described above in FIG. 1 and FIG. 2. Identical elements are therefore provided in FIG. 3 with the same reference symbols as in FIG. 1 or FIG. 2. The essential differences of the inventive embodiment in accordance with FIG. 3 as compared with the commercially available embodiment in accordance with FIG. 1 and FIG. 2 consist in that the crossbeam 1 is fixedly connected to the first support element 2 and is movably connected to the second support element 3 in such a way that the crossbeam 1 and the second support element 3 can be moved relative to one another, the measuring element 4 being fixedly connected to the second support element 3 and being movably connected to the first support element 2 in such a way that the measuring element 4 and the first support element 2 can be moved relative to one another. Compared with the commercial embodiment in accordance with FIG. 1 and FIG. 2, the crossbeam 1 is thus no longer connected as rigidly as possible to the two support elements 2 and 3, but the crossbeam 1 can be moved to a certain extent relative to the second support element 3. Movement between the crossbeam 1 and the second support element 3 usually takes place in this case in the micrometer range and/or, depending on the embodiment of the machine, in the millimeter range. The crossbeam 1 is therefore only connected as fixedly, that is to say rigidly, as possible to the first support element 2.

Furthermore, by contrast with the commercial embodiment in accordance with FIG. 1 and FIG. 2, in the case of the inventive machine the measuring element 4 is also no longer fixedly connected to the crossbeam 1, but the measuring element 4 is arranged to be capable of moving relative to the crossbeam 1 by fixedly connecting it to the second support element 3 and movably connecting it to the first support element 2 such that the measuring element 4 and the first support element 2 can be moved relative to one another.

In this case, the measuring element 4 is preferably movably connected to the first support element 2 via a first bearing 8, and the crossbeam 1 is preferably movably connected to the second support element 3 via a second bearing 9. The bearings can in this case be designed as plain bearings, magnetic bearings or as rolling contact bearings.

The invention solves the problem described by decoupling the intrinsic movements of the support elements. By virtue of the fact that the crossbeam 1 is fixedly connected only to the first support element 2, in the event of a movement in the X-direction of the linear motor 5, as illustrated by way of example in FIG. 3, the force in the X-direction is transmitted only to the first support element 2, which is deformed by the action of force as illustrated in FIG. 3, given an acceleration of the linear motor 5. Since the crossbeam 1 is movably arranged relative to the second support element, the second support element 3 remains at rest and is not deformed. Since the graduated scale is fixedly connected only to the second (nondeformed) support element 3, and is movably connected to the first support element 2, the deformation of the first support element 2 is likewise not transmitted to the measuring element 4, and thus neither to the position measuring system. Since the intrinsic movement of the crossbeam 1 is therefore no longer present as interference in the feedback of the position measurement signal for regulating the control of the movement of the linear motor 5, substantially higher accuracies and a higher machine dynamics can be realized during processing.

FIG. 4 illustrates a further embodiment of the inventive machine. The basic design of the embodiment illustrated in FIG. 4 corresponds substantially to the embodiment described above in FIG. 3. Identical elements are therefore provided with the same reference symbols in FIG. 4 as in FIG. 3. The single essential difference consists in that in the embodiment in accordance with FIG. 4 the first bearing 8 and the second bearing 9 are not designed as plain bearings, magnetic bearings or as rolling contact bearings, but are implemented as deformable bearings that are designed in the form of a plate in the exemplary embodiment. In this case, the crossbeam 1 is connected to the second support element 3 in the exemplary embodiment via vertically arranged plates 9. The measuring element 4 is likewise connected to the first support element 2 via vertically arranged plates 8. The arrangement of the plates 9 ensures that the crossbeam 1 can move relative to the second support element 3 without the second support element 3 being deformed, since only very slight forces are required in the X-direction in order to bend the plates. Analogously, it is also possible for a movement to take place between the measuring element 4 and the first support element 2 by means of the plates 8. However, owing to the fact that the plates are of high stiffness in the horizontal Y-direction (see FIG. 4), designing the bearings as deformable bearings, particularly in the form of the proposed plates, also simultaneously implements a high stiffness of the arrangement, in particular of the crossbeam 1 in the Y-direction, that is to say in the horizontal direction looking into the drawing. Deformable bearings can be implemented particularly easily with the aid of plates.

Of course, it is not absolutely necessary to provide a number of plates in order to construct a deformable bearing, it also being possible to construct the deformable bearing only with the aid of a single plate.

Furthermore, it is also possible, of course, to design one of the two bearings as a deformable bearing, while the other bearing is designed as, for example, a plain bearing, magnetic bearing or as a rolling contact bearing.

1.-8. (canceled)

9. A machine, comprising:
a support structure having first and second support elements;
a crossbeam carried by the support structure, said crossbeam being fixedly connected to the first support element and movably connected to the second support element in such a way that the crossbeam and the second support element are moveable relative to one another;
a machine element movable along the crossbeam; and
a measuring element for measuring a position of the machine element, said measuring element being fixedly connected to the second support element and movably connected to the first support element in such a way that the measuring element and the first support element are movable relative to one another.

10. The machine of claim 9, wherein the machine element is designed as a drive.

11. The machine of claim 10, wherein the drive is a linear drive.

12. The machine of claim 9, further comprising a bearing for movably connecting the measuring element to the first support element.

13. The machine of claim 12, wherein the first bearing is a member selected from the group consisting of plain bearing, magnetic bearing, rolling contact bearing, and deformable bearing.

14. The machine as claimed in claim 13, wherein the deformable bearing is designed in the form of a plate.

15. The machine of claim 9, further comprising a bearing for movably connecting the crossbeam to the second support element.

16. The machine of claim 15, wherein the first bearing is a member selected from the group consisting of plain bearing, magnetic bearing, rolling contact bearing, and deformable bearing.

17. The machine of claim 15, wherein the deformable bearing is designed in the form of a plate.

18. The machine of claim 9, wherein the machine is a member selected from the group consisting of machine tool, production machine, and robot.
